(19) United States
(12) Patent Application Publication
(10) Pub. No.: US 2026/0229160 A1
(43) Pub. Date: Aug. 6, 2026

(54) DISPLAY DEVICE AND DRIVING METHOD THEREOF

(71) Applicant: SAMSUNG ELECTRONICS CO., LTD., Suwon-si (KR)

(72) Inventors: Seoyoung KIM, Suwon-si (KR); Jungmin KU, Suwon-si (KR); Sunghwan JANG, Suwon-si (KR)

(73) Assignee: SAMSUNG ELECTRONICS CO., LTD., Suwon-si (KR)

(21) Appl. No.: 19/635,374

(22) Filed: Mar. 31, 2026

Related U.S. Application Data
(63) Continuation of application No. PCT/KR2024/015400, filed on Oct. 11, 2024.

(30) Foreign Application Priority Data
Oct. 12, 2023 (KR) 10-2023-0136048

(51) Int. Cl. G09G 3/20

(52) U.S. Cl. CPC G09G 3/2092; G09G 2310/08; G09G 2320/041; G09G 2320/0626; G09G 2330/026

(57) ABSTRACT

A display device may comprise: a display panel configured to display an image; a timing controller configured to control a data signal and a gate signal; and a compensation unit configured to compensate for luminance of the image displayed on the display panel. The compensation unit detects generation of a power-on signal, calculates a temperature difference between a reference saturation temperature and a current IC temperature, and controls a starting level of a compensation algorithm based on the temperature difference.

### CROSS-REFERENCE TO RELATED APPLICATIONS

This application is a continuation application, under 35 U.S.C. § 111(a), of an International Application No. PCT/KR 2024/015400, filed on Oct. 11, 2024, claiming priority to Korean Patent Application Number 10-2023-0136048, filed on Oct. 12, 2023, the disclosures of which are incorporated by reference herein in their entireties.

### TECHNICAL FIELD

Various embodiments of the disclosure relate to a display device performing luminance compensation and a driving method thereof.

### BACKGROUND ART

Along with the development of digital technology, various types of electronic devices such as a smart TV, a smart phone, a tablet PC, an electronic notebook, a personal digital assistant (PDA), or a wearable device are being used. In particular, various types of electronic devices may be implemented as a display device that outputs an image to a display panel based on input data.

The display device may convert various information into its visual form and provide the same to a user. Generally, the display device may include a plurality of components so as to enable various information to be displayed according to electrical signals. For example, the plurality of components may include a plurality of pixels included in a display panel.

In an ideal display panel, a plurality of pixels may output light with the same luminance, when the same signal is provided to the plurality of pixels. However, However, due to errors in the manufacturing process or various environmental factors in actual display panels, such a plurality of pixels may not be able to output light with the same luminance for the same signal. For example, in a display panel, the light efficiency of a red (R) LED, a green (G) LED, or a blue (B) LED may decrease in the plurality of pixels due to heat generated by the operation of the device. Particularly, R LEDs are more significantly affected by the heat generation compared to G LEDs or B LEDs, thereby leading to a problem that the color of an image provided to a user is distorted.

### DISCLOSURE OF INVENTION

### Solution to Problems

Various embodiments of the disclosure may provide a display device and a driving method thereof that perform a luminance compensation optimized for a service environment, by controlling a starting level of a compensation algorithm based on a current integrated circuit (IC) temperature at the time of a booting.

A display device according to embodiments of the disclosure may include a display panel configured to display an image, a timing controller configured to control a data signal and a gate signal, and a compensation unit configured to compensate for luminance of the image displayed on the display panel. The compensation unit may detect generation of a power-on signal, calculate a temperature difference between a reference saturation temperature and a current integrated circuit (IC) temperature, and control a starting level of a compensation algorithm based on the temperature difference.

In an embodiment, the compensation algorithm may include an optimum gain based a relative driving time after a cold boot timing point of at least one of a red subpixel, a green subpixel, and a blue subpixel.

In an embodiment, the compensation unit may calculate the temperature difference based on a difference value between a pre-stored reference saturation temperature and the current IC temperature received from at least one temperature sensor.

In an embodiment, the compensation unit may classify a booting timing at which the power-on signal is generated into any one section of a relative driving time based on the temperature difference.

In an embodiment, the compensation unit may classify the booting timing into a first section based on the temperature difference being in a range exceeding 20° C., classify the booting timing into a second section based on the temperature difference being in a range exceeding 15° C. and less than or equal to 20° C., classify the booting timing into a third section based on the temperature difference being in a range exceeding 10° C. and less than or equal to 15° C., classify the booting timing into a fourth section based on the temperature difference being in a range exceeding 5° C. and less than or equal to 10° C., and classify the booting timing into a fifth section based on the temperature difference being in a range of 5° C. or less.

In an embodiment, the compensation unit may start the compensation algorithm from a predetermined timing point corresponding to the temperature difference within the any one section of the relative driving time at the booting timing.

In an embodiment, at the booting timing, the compensation algorithm may perform a luminance compensation for at least one of a red subpixel, a green subpixel, and a blue subpixel by applying an optimum gain corresponding to the predetermined timing point corresponding to the temperature difference.

In an embodiment, the compensation unit may determine whether a driving time of the display panel is greater than or equal to a reference driving time, and based on the driving time of the display panel being greater than or equal to the reference driving time, update the current IC temperature at a driving end time of the display panel to the reference saturation temperature.

In an embodiment, the compensation unit may recognize the driving end time based on at least one of a termination signal, a standby mode signal, and a restart signal of the display panel.

In an embodiment, the compensation unit may, based on the power-on signal being generated, calculate the temperature difference by comparing the updated reference saturation temperature with the current IC temperature at the booting timing at which the power-on signal is generated.

A driving method of a display device according to embodiments of the disclosure may include controlling a data signal and a gate signal, displaying an image, and compensating for luminance of the displayed image. An operation of compensating for the luminance may include detecting generation of a power-on signal, calculating a temperature difference between a reference saturation temperature and a current IC temperature, and controlling a starting level of a compensation algorithm based on the temperature difference.

In an embodiment, the compensation algorithm may include an optimum gain according to a relative driving time after a cold boot timing point of at least one of a red subpixel, a green subpixel, and a blue subpixel.

In an embodiment, an operation of calculating the temperature difference may include calculating the temperature difference based on a difference value between a pre-stored reference saturation temperature and the current IC temperature received from at least one temperature sensor.

In an embodiment, an operation of controlling the starting level of the compensation algorithm may classify a booting timing at which the power-on signal is generated into any one section of a relative driving time based on the temperature difference.

In an embodiment, the operation of controlling the starting level of the compensation algorithm may classify the booting timing into a first section based on the temperature difference being in a range exceeding 20° C., classify the booting timing into a second section based on the temperature difference being in a range exceeding 15° C. and less than or equal to 20° C., classify the booting timing into a third section based on the temperature difference being in a range exceeding 10° C. and less than or equal to 15° C., classify the booting timing into a fourth section based on the temperature difference being in a range exceeding 5° C. and less than or equal to 10° C., and classify the booting timing into a fifth section based on the temperature difference being in a range of 5° C. or less.

In an embodiment, the operation of controlling the starting level of the compensation algorithm may start the compensation algorithm from a predetermined timing point corresponding to the temperature difference within the any one section of the relative driving time at the booting timing.

In an embodiment, at the booting timing, the compensation algorithm may perform a luminance compensation for at least one of a red subpixel, a green subpixel, and a blue subpixel by applying an optimum gain corresponding to the predetermined timing point corresponding to the temperature difference.

In an embodiment, the operation of compensating for the luminance may further include determining whether a driving time of the display panel is greater than or equal to a reference driving time, and based on the driving time of the display panel being greater than or equal to the reference driving time, updating the current IC temperature at a driving end time of the display panel to the reference saturation temperature.

In an embodiment, an operation of determining whether the driving time of the display panel is greater than or equal to the reference driving time may recognize the driving end time based on at least one of a termination signal, a standby mode signal, and a restart signal of the display panel.

In an embodiment, the operation of calculating the temperature difference may, upon generation of the power-on signal, calculate the temperature difference by comparing the updated reference saturation temperature with the current IC temperature at the booting timing at which the power-on signal is generated.

According to various embodiments of the disclosure, a display device and a driving method thereof according to the disclosure may calculate a temperature difference between a reference saturation temperature and a current IC temperature at booting, and determine a starting level of a compensation algorithm based on the temperature difference. Accordingly, the display device and the driving method thereof according to the disclosure may reflect a use environment before and after power booting to perform luminance compensation optimized for the use environment.

Effects that can be obtained from example embodiments of the disclosure are not limited to those mentioned above, and other effects not mentioned herein may be clearly derived and understood by those having ordinary knowledge in the technical field to which the example embodiments of the disclosure belongs from the following description. In other words, any unintended effects of implementing example embodiments of the disclosure may also be derived by those having ordinary knowledge in the technical field from the example embodiments of the disclosure.

### BRIEF DESCRIPTION OF DRAWINGS

FIG. 1 illustrates a change in color of an image due to deterioration of a display device according to an embodiment.

FIG. 2 illustrates components of a display device according to an embodiment.

FIG. 3 illustrates a block diagram of configuration of a display device according to an embodiment.

FIG. 4 illustrates an optimum gain of a compensation algorithm according to an embodiment.

FIG. 5 illustrates a sequence of compensation operations of a compensation unit according to an embodiment.

FIG. 6 illustrates classification of sections according to a temperature difference between a reference saturation temperature and a current IC temperature according to an embodiment.

FIG. 7 illustrates an operation of a compensation unit controlling a starting level of a compensation algorithm according to an embodiment.

FIG. 8 illustrates a section classification according to an example test temperature difference according to an embodiment.

FIG. 9 illustrates a starting level of a compensation algorithm according to an example test temperature difference according to an embodiment.

FIG. 10 illustrates an optimum gain applied upon booting according to an example test temperature difference according to an embodiment.

FIG. 11 illustrates an operation of a compensation unit updating a reference saturation temperature according to an embodiment.

### MODE FOR THE INVENTION

Hereinafter, embodiments of the disclosure will be described in detail with reference to the drawings such that a person having ordinary knowledge in the technical field to which the disclosure belongs may easily implement the embodiments. However, the disclosure may be implemented in various different forms and is not limited to the embodiments described herein. In relation to the description of the drawings, the same or similar reference numerals may be used for the same or similar components. Further, in the drawings and related description, the descriptions of well-known functions and configurations may not be reiterated for clarity and brevity.

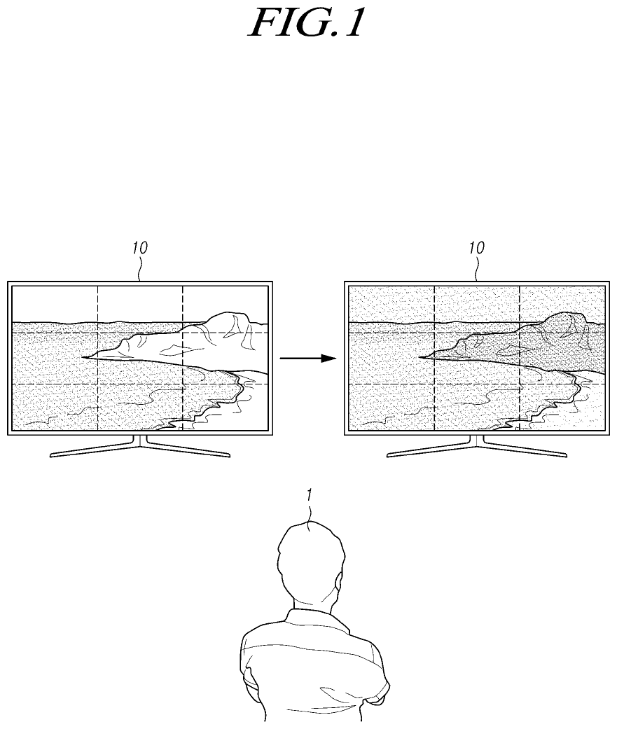

FIG. 1 illustrates a change in color of an image due to deterioration of a display device according to an embodiment,

Referring to FIG. 1, a display device 10 may output and provide an image to a user 1. The display device 10 may be implemented as, for example, a smart phone, a tablet, a smart TV, an Internet TV, a web TV, an Internet protocol television (IPTV), signage, a personal computer (PC), a monitor, and the like, but the disclosure is not limited thereto. For example, the display device 10 may be implemented as various types of devices having a display function such as a large format display (LFD), digital signage, a digital information display (DID), a video wall, a projector display, and the like.

The display device 10 may include a micro LED panel. In such a case, luminous efficiency of LED elements included in the display device 10 may decrease due to heat generated by the display device 10. A portion of the amount of power supplied to the LED elements with the decreased luminous efficiency may be dissipated in the form of thermal energy, which may cause a problem of further decreasing the luminous efficiency of the corresponding LED elements and their surrounding LED elements.

As heat is generated from the display device 10 while the user 1 uses the display device 10, the color of the image provided by the display device 10 may be distorted.

Specifically, the image provided by the display device 10 may become slightly darker by the heat generation, and red light emitted by R (Red) LEDs, which may be more affected by heat than other LED devices, may relatively decrease, causing the color of the image to be distorted. Further, as shown in FIG. 1, a bright portion included in the image may generate relatively more heat than a dark portion included in the image, and thus the color distortion in the bright portion may occur more significantly than the color distortion in the dark portion.

According to an embodiment of the disclosure, in order to address the problem of distortion of color of the image provided to the user 1 due to heat generation, the display device 10 may adjust luminance of the display device 10 based on heat generation estimation data obtained as a result of analyzing an input image. Originally, the term “luminance” may be referred to encompass a concept related to both a brightness of an image provided through a display panel 100 and an intensity of a driving signal provided by a main controller 500 to the display panel 100 via a timing controller 200, but in this specification, the description of operation of the display device 10 will be made on the premise that the luminance has the latter meaning.

The display device 10 with corrected luminance may emit less heat than before the luminance was corrected, so that the color distortion of the image provided to the user 1 may also be reduced. Hereinafter, various embodiments of correcting the luminance of the display device 10 based on the heat generation estimation data obtained by analyzing the input image will be described in more detail.

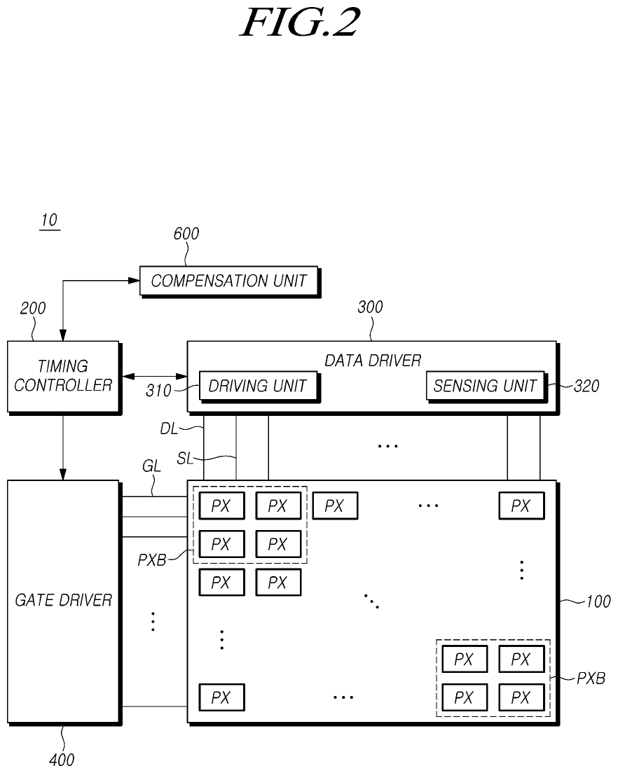

FIG. 2 illustrates components of a display device according to an embodiment.

Referring to FIG. 2, the display device 10 may include a display panel 100, a timing controller 200, a data driver 300, a gate driver 400, and a compensation unit 600. According to various embodiments, the display panel 100, the timing controller 200, the data driver 300, the gate driver 400, and the compensation unit 600 may be implemented as a single module. For example, the timing controller 200, the data driver 300, the gate driver 400, and the compensation unit 600 may be mounted on a circuit film such as tape carrier package (TCP), chip on film (COF), flexible printed circuit (FPC), and the like, and may be attached to the display panel 100 in tape automatic bonding (TAB) or mounted on a non-display area of the display panel 100 in chip on glass (COG) method.

The display panel 100 may include a plurality of signal lines, for example, a plurality of gate lines (GL), a plurality of data lines (DL), and a plurality of sensing lines (SL), and may include a plurality of pixels (PX), for example, a pixel array, connected to the plurality of signal lines and arranged in a matrix form. The plurality of pixels (PX) may display one of red, green, and blue colors, in which a pixel displaying red, a pixel displaying green, and a pixel displaying blue may be repeatedly arranged in sequence. Then, the user may recognize light of one color in which red, green, and blue light displayed in adjacent pixels (PX) are mixed. According to various embodiments, pixels displaying red, green, and blue are referred to as a red subpixel, a green subpixel, and a blue subpixel, respectively, and a group of the red subpixel, the green subpixel, and the blue subpixel may be referred to as a pixel. For example, the plurality of pixels (PX) may display one of red, green, blue, and white colors. However, the disclosure is not limited thereto, and the composition of colors that the pixels can display may be freely adopted within the scope of conventional technology.

The display panel 100 may be an OLED display panel in which each pixel (PX) includes a light emitting element, for example, an organic light emitting diode (OLED). However, the disclosure is not limited thereto, and the display panel 100 may include at least one display panel of a liquid crystal display (LCD), a light emitting diode (LED), a light emitting polymer display (LPD), an organic light emitting diode (OLED), an active matrix organic light emitting diode (AMOLED), a flexible LED (FLED) or the like.

The timing controller 200 may control overall operations of the display device 10, and may control driving timings of the data driver 300 and the gate driver 400 based on control commands received from an external processor, for example, a main processor of an electronic device on which the display device 10 is mounted or an image processing processor. The timing controller 200 may be implemented in hardware, software, or a combination of hardware and software. For example, the timing controller 200 may be implemented with digital logic circuits and registers that perform functions to be described later.

The timing controller 200 may provide a data driver control signal to the data driver 300, and control the operation and operation timings of a driving unit 310 and a sensing unit 320 of the data driver 300, in response to the data driver control signal. The timing controller 200 may provide a gate driver control signal to the gate driver 400. The gate driver 400 may drive the plurality of gate lines (GL) of the display panel 100, in response to the gate driver control signal. The timing controller 200 may perform various image processing for image data received from an external processor, such as changing then format of the image data, reducing power consumption, compensating for luminance, and the like. For example, the image data may include input data corresponding to each pixel (PX), and the timing controller 200 may perform data compensation for image data of each pixel (PX), in order to compensate for luminance of the plurality of pixels (PX) of the display panel 100, and provide the compensated data to the data driver 300. For this purpose, the timing controller 200 may include a storage (not shown). For example, the storage of the timing controller 200 may be implemented as a memory.

In an embodiment, the timing controller 200 may receive compensation data from the compensation unit 600. For example, the compensation data may include a luminance compensation value based on heat generation estimation data obtained by analyzing input data corresponding to each pixel (PX). For example, the timing controller 200 may perform data compensation for image data based on the compensation data, and provide the compensated data to the data driver 300. Specifically, the timing controller 200 may control luminance and grayscale of the image data by applying compensation data in each subpixel unit (e.g., red subpixel (R LED), green subpixel (G LED), and blue subpixel (B LED)) of the plurality of pixels (PX).

The data driver 300 may include a driving unit 310 and a sensing unit 320. The data driver 300 may drive the plurality of pixels (PX) through the plurality of data lines (DL) based on the data driver control signal received from the timing controller 200. The data driver 300 may sense (measure) electrical characteristics of the plurality of pixels (PX) through the plurality of sensing lines (SL) based on the data driver control signal received from the timing controller 200.

The driving unit 310 may make digital-to-analog conversion of image data received from the timing controller 200, for example, compensated input data for each of the plurality of pixels (PX), and provide driving signals, which are the converted analog signals, to the display panel 100 through the plurality of data lines (DL).

The timing controller 200 may operate the data driver 300 in a display mode for displaying an image or in a sensing mode for performing a sensing process. For example, the driving unit 310 may, in the display mode, convert image data provided from the timing controller 200 into driving signals, e.g., driving voltages, and output the driving voltages to the data lines (DL) of the display panel 100. For example, in the sensing mode, the driving unit 310 may convert internally set sensing data, provided from the timing controller 200, into driving signals, e.g., driving voltages, and output the driving voltages to the data lines (DL) of the display panel 100.

In an embodiment, the timing controller 200 may transmit a sensing control signal to the driving unit 310 to perform a sensing process, and then the sensing unit 320 may sense (measure) the electrical characteristics of each pixel (PX) via the sensing line SL and transmit the measured sensing value to the timing controller 200. The sensing control signal may include a sensing period, a position of a sensing pixel block, a sensing scheme, and the like. The sensing scheme may include, for example, at least one of measuring a threshold voltage of a driving transistor provided in the pixel (PX), measuring a potential difference between both ends of the light emitting element provided in the pixel (PX), or measuring an amount of current flowing through the light emitting element or a mobility.

The sensing unit 320 may receive, through the plurality of sensing lines SL, a sensing signal indicating an electrical characteristic of each of the plurality of pixels (PX), for example, a pixel voltage or a pixel current, and generate sensing data by analog-to-digital conversion of the sensing signal. For example, the sensing data may include at least one of a threshold voltage of a driving transistor provided in the pixel, a potential difference between both ends of the light emitting element provided in the pixel, or an amount of current flowing through the light emitting element or a mobility.

The gate driver 400 may drive a plurality of gate lines (GL) of the display panel 100 using the gate driver control signal received from the timing controller 200. The gate driver 400 may provide pulses of a gate-on voltage, for example, a scan voltage or a sensing-on voltage, to the corresponding gate line (GL) in a corresponding driving period of each of the plurality of gate lines (GL), based on the gate driver control signal.

The compensation unit 600 may generate compensation data for compensating for luminance and gray scale of an output image based on the input data. For example, the compensation data may include a luminance compensation value based on heat generation estimation data obtained by analyzing input data corresponding to each pixel (PX).

The compensation unit 600 may control the luminance and gray scale of the output image by adjusting a luminance gain of at least one subpixel (e.g., a red subpixel (R LED), a green subpixel (G LED), and a blue subpixel (B LED)), based on a compensation algorithm. For example, the compensation algorithm may include an optimum gain according to a relative driving time of at least one of the red subpixel, the green subpixel, and the blue subpixel. The compensation unit 600 may compensate for the image data of each subpixel by transmitting, to t he timing controller 200, compensation data to which the optimum gain according to the relative driving time of the subpixel is applied.

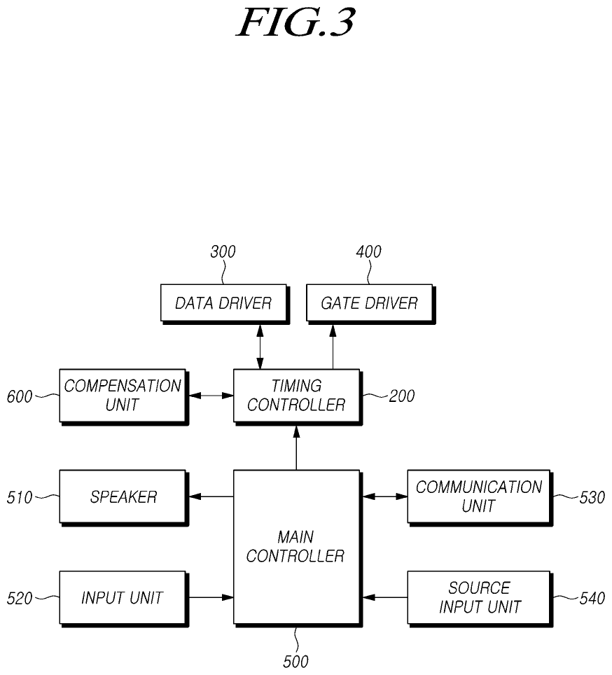

FIG. 3 illustrates a block diagram of configuration of a display device according to an embodiment.

Referring to FIG. 3, the display device 10 according to an embodiment may include the timing controller 200, the data driver 300, the gate driver 400, and the compensation unit 600 as described above, and may further include a main controller 500 for controlling the timing controller 200, a communication unit 530 for communicating with an external device, a source input unit 540 receiving a source image, a speaker 510 outputting sound, and an input unit 520 receiving commands for controlling the display device 10 from a user.

The input unit 520 may include a button or a touch pad provided in an area of the display device 10, and when the display panel 100 is implemented as a touch screen, the input unit 520 may include a touch pad provided on a front surface of the display panel 100. Further, the input unit 520 may include a remote controller for remotely receiving a user input and/or a microphone for receiving voice commands.

The input unit 520 may receive various commands for controlling the display device 10 from a user, such as power on/off, volume adjustment, channel adjustment, screen adjustment, various setting changes, and the like of the display device 10. The speaker 510 may output sound synchronized with an image output from the display panel 100 under the control of the main controller 500.

The communication unit 530 may communicate with a relay server or another electronic device to transmit or receive necessary data therethrough. The communication unit 530 may employ at least one of various wireless communication schemes such as 3G (3rd generation), 4G (4th generation), wireless LAN, Wi-Fi, Bluetooth, Zigbee, Wi-Fi Direct (WFD), Ultra-wideband (UWB), Infrared Data Association (IrDA), Bluetooth Low Energy (BLE), Near Field Communication (NFC), and Z-Wave. In addition, the communication unit 530 may also employ a wired communication scheme such as Peripheral Component Interconnect (PCI), PCI-express, or Universal Serial Bus (USB).

The source input unit 540 may receive a source signal input from a game console, a set-top box, a USB, an antenna, etc. Therefore, the source input unit 540 may include at least one selected from a group of source input interfaces including an HDMI cable port, a USB port, an antenna, and the like. The source signal received by the source input unit 540 may be processed by the main controller 500 to be converted into a form capable of being output from the display panel 100 and/or the speaker 510.

The main controller 500 and the timing controller 200 may include a program for performing the above-described operation and the operation to be described later, at least one memory for storing various data, and at least one processor for executing the stored program. The memory composing the main controller 500 and the timing controller 200 may include a volatile memory such as a static random access memory (S-RAM), a dynamic random access memory (D-RAM), and a nonvolatile memory such as a read only memory (ROM) and an erasable programmable read only memory (EPROM). The memory may include one memory device or a plurality of memory devices.

At least one processor making up the main controller 500 and the timing controller 200 may execute a program stored in each memory. According to various embodiments, the main controller 500 may generate an image signal corresponding to the input source signal by processing a source signal input via the source input unit 540 and/or a source signal wirelessly received via the communication unit 530. For example, the main controller 500 may include a source decoder, a scaler, an image enhancer, and a graphics processor. The source decoder may decode the source signal compressed in the form of MPEG or the like, and the scaler may output image data with a desired resolution by resolution conversion.

The image enhancer may improve the image quality of image data by applying correction of various techniques. The graphic processor may divide a pixel of image data into RGB data and output the same along with a control signal such as a synchronizing signal for display timing on the display panel 100. That is, the main controller 500 may output image data and a control signal corresponding to the source signal. Further, the main controller 500 may change a frame rate of image data to correspond to the frame rate of the source signal. As such, the display device 10 may allow the frame rate to be varied depending on the source signal, thereby outputting the source signal without degradation.

According to various embodiments, the main controller 500 and the timing controller 200 may be provided on separate boards or on the same board. For example, the main controller 500 may be provided on a main board, and the timing controller 200 may be provided on a drive board, but the disclosure is not limited thereto.

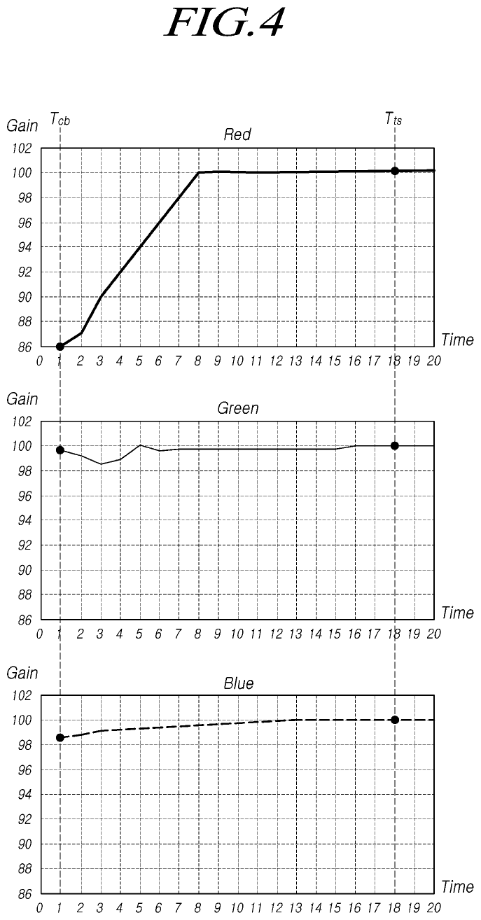

FIG. 4 illustrates an optimum gain of a compensation algorithm according to an embodiment.

Referring to FIG. 4, the compensation unit 600 may generate compensation data for compensating for luminance and grayscale of an output image based on input data. For example, the compensation data may include a luminance compensation value based on heat generation estimation data obtained by analyzing input data corresponding to each pixel (PX). The compensation unit 600 may control luminance and grayscale of the output image by adjusting a luminance gain of at least one subpixel (e.g., a red subpixel (R LED), a green subpixel (G LED), a blue subpixel (B LED)) based on a compensation algorithm.

For example, as shown in FIG. 4, the compensation algorithm may include an optimum gain according to a relative driving time after a cold boot timing point T_{cb} of at least one of the red subpixel, the green subpixel, and the blue subpixel. For example, the compensation algorithm may include the optimum gain according to the relative driving time from the cold boot timing point T_{cb} up to the temperature saturation timing point Tₜₛ at which the temperature rise of the display panel 100 is saturated. Here, the cold boot refers to power being turned on from a state in which the power of the display device 10 is completely turned off, and it may mean a state in which the internal temperature of the display device 10 is lowered to the extent that the difference from the external temperature (e.g., the ambient temperature of an environment in use) is almost eliminated after a sufficient time has passed since the display device 10 is turned off. For example, the cold boot timing point T_{cb} may refer to a timing point when the current temperature of the display device 10 is significantly different from the highest heating temperature (e.g., a reference saturation temperature) since the display device 10 has not been used for a long period of time.

The optimum gain according to the relative driving time may have different gain values based on heat generation estimation data of each subpixel. For example, the optimum gain according to the relative driving time of the red subpixel may start at 86 at the cold boot timing point T_{cb} and may be maintained at 100 after the temperature saturation timing point Tₜₛ. For example, the optimum gain according to the relative driving time of the green subpixel may start at 99.6 at the cold boot timing point T_{cb} and may be maintained at 100 after the temperature saturation timing point Tₜₛ. For example, the optimum gain according to the relative driving time of the blue subpixel may start at 98.5 at the cold boot timing point T_{cb} and may be maintained at 100 after the temperature saturation timing point Tₜₛ.

Meanwhile, when the compensation algorithm is collectively applied from the cold boot timing point T_{cb} during booting of the display device 10, the compensation algorithm may be re-executed from the beginning even in case where the power of the display device 10 is temporarily (e.g., momentarily) turned off and then back on, and thus, compensation data that is not optimized for the service environment of the display device 10 may be applied. On the other hand, as described later, the display device 10 according to embodiments of the present disclosure may perform luminance compensation optimized for the service environment by comparing the reference saturation temperature with the current IC temperature at the time of booting to determine a starting level of the compensation algorithm.

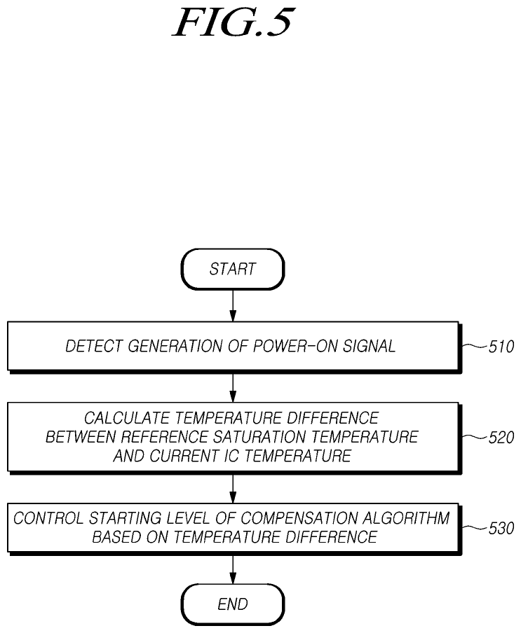

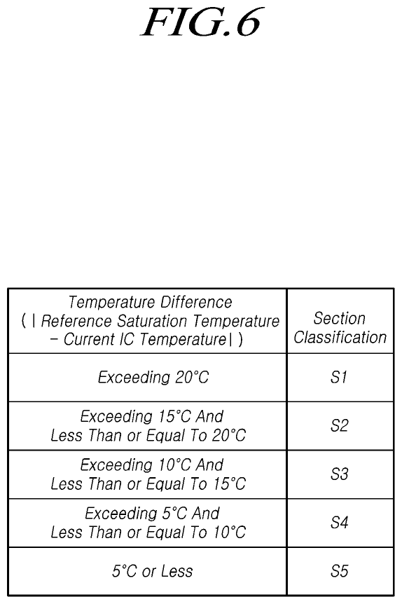

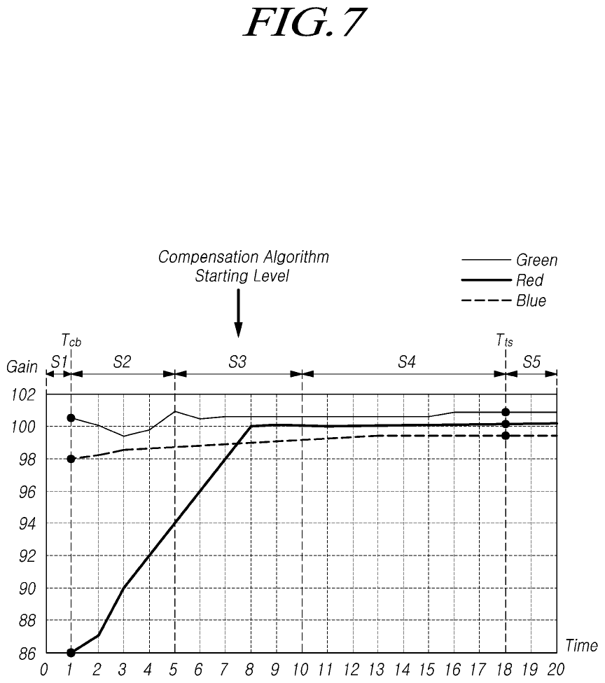

FIG. 5 illustrates a sequence of compensation operations of a compensation unit 600 according to an embodiment, FIG. 6 illustrates a section classification according to a temperature difference between a reference saturation temperature and a current IC temperature according to an embodiment, and FIG. 7 illustrates an operation of the compensation unit 600 controlling a starting level of a compensation algorithm according to an embodiment.

Referring to FIG. 5, the compensation unit 600 may detect occurrence of a power-on signal (operation 510), calculate a temperature difference between the reference saturation temperature and the current IC temperature (operation 520), and control a starting level of a compensation algorithm based on the temperature difference (operation 530).

According to an example, in operation 510, the compensation unit 600 may detect generation of a power-on signal. For example, the compensation unit 600 may detect the power-on signal generated based on power applied via an input unit (e.g., the input unit 520 of FIG. 3). The compensation unit 600 may detect a booting of the display device 10 based on the power-on signal. For example, the booting of the display device 10 may be a cold boot in which power is turned on in a state that power of the display device 10 is completely turned off. For example, the booting of the display device 10 may be a rebooting in which power of the display device 10 is temporarily turned off and then turned on according to an instantaneous power-on and power-off.

According to an embodiment, in operation 520, the compensation unit 600 may calculate a temperature difference between a reference saturation temperature and a current IC temperature. For example, the compensation unit 600 may compare the reference saturation temperature with the current IC temperature at the booting timing of the display device 10, and then calculate a temperature difference between the reference saturation temperature and the current IC temperature. The reference saturation temperature may refer to a temperature of the display panel 100 at a temperature saturation timing point Tₜₛ. The compensation unit 600 may store and update the reference saturation temperature. The current IC temperature may refer to a real-time temperature of the display panel 100. For example, the compensation unit 600 may receive sensing data including the current IC temperature of the display panel 100 in real time from at least one temperature sensor.

The compensation unit 600 may calculate the temperature difference based on a difference value between the pre-stored reference saturation temperature and the current IC temperature received from at least one temperature sensor. For example, when the display device 10 is booted according to application of power at the cold boot timing point T_{cb}, the temperature difference between the reference saturation temperature and the current IC temperature may have a relatively large difference (e.g., above 20° C.). For example, when the display device 10 is momentarily terminated and then rebooted at the temperature saturation timing point Tₜₛ, the temperature difference between the reference saturation temperature and the current IC temperature may have a relatively small difference (e.g., 5° C. or less).

According to an embodiment, in operation 530, the compensation unit 600 may control a starting level of the compensation algorithm based on the temperature difference. For example, the compensation unit 600 may classify a booting timing at which the power-on signal is generated into any one section of the relative driving time, based on the temperature difference between the reference saturation temperature and the current IC temperature. For example, at the booting timing, the compensation unit 600 may initiate the compensation algorithm at a predetermined timing point corresponding to the temperature difference between the reference saturation temperature and the current IC temperature of the any one section of the relative driving time.

The compensation unit 600 may classify the temperature difference between the reference saturation temperature and the current IC temperature into a predetermined number of groups. For example, as shown in FIG. 6, the compensation unit 600 may classify the temperature difference between the reference saturation temperature and the current IC temperature into a first group whose temperature difference is greater than 20° C., a second group whose temperature difference is greater than 15° C. and less than or equal to 20° C., a third group whose temperature difference is greater than 10° C. and less than or equal to 15° C., a fourth group whose temperature difference is greater than 5° C. and less than or equal to 10° C., and a fifth group whose temperature difference is less than or equal to 5° C.

Here, the first group may include a temperature difference between the reference saturation temperature and the current IC temperature, when the display device 10 is cold-booted. The second group may include a temperature difference between the reference saturation temperature and the current IC temperature, when the display device 10 is powered off for a long time (e.g., for 15 to 30 minutes) and then booted. The third group may include a temperature difference between the reference saturation temperature and the current IC temperature, when display device 10 is powered off for an appropriate time (e.g., for 5 to 15 minutes) and then booted. The fourth group may include a temperature difference between the reference saturation temperature and the current IC temperature, when the display device 10 is powered off for a short time (e.g., for 1 to 5 minutes) and then booted. The fifth group may include a temperature difference between the reference saturation temperature and the current IC temperature, when the display device 10 is instantaneously powered off (e.g., for 1 minute or less) and then booted.

The compensation unit 600 may classify each of the booting timings of the first to fifth groups into any one section of the relative driving time of the compensation algorithm. For example, the compensation unit 600 may classify the booting timing into a first section S1 for the first group in which the temperature difference is in the range of greater than 20° C. For example, the compensation unit 600 may classify the booting timing into a second section S2 for the second group in which the temperature difference is in the range of greater than 15° C. and less than or equal to 20° C. For example, the compensation unit 600 may classify the booting timing into a third section S3 for the third group in which the temperature difference is in the range of greater than 10° C. and less than or equal to 15° C. For example, the compensation unit 600 may classify the booting timing into a fourth section S4 for the fourth group in which the temperature difference is in the range of greater than 5° C. and less than or equal to 10° C. For example, the compensation unit 600 may classify the booting timing into a fifth section S5 for the fifth group in which the temperature difference is in the range of 5° C. or less.

The compensation unit 600 may initiate the compensation algorithm from a predetermined timing point corresponding to a temperature difference between the reference saturation temperature and the current IC temperature among the first to fifth sections (e.g., S1, S2, S3, S4, and S5) of the relative driving time, at the booting timing. As shown in FIG. 7, the compensation algorithm may control a compensation algorithm starting level at the booting timing, thereby applying to the subpixel an optimum gain corresponding to the predetermined timing point corresponding to the temperature difference. For example, at the booting timing, the compensation algorithm may initiate the compensation for the luminance of at least one of the red subpixel, the green subpixel, and the blue subpixel from any one of the first to fifth sections (e.g., S1, S2, S3, S4, and S5) or at a predetermined timing point.

For example, when the compensation algorithm starts from the first section (S1) where the temperature difference between the reference saturation temperature and the current IC temperature is in the range of more than 20° C., the compensation unit 600 may recognize the booting as a cold boot and start the compensation algorithm from the beginning. For example, when the compensation algorithm starts from the fifth section (S5) where the temperature difference between the reference saturation temperature and the current IC temperature is within the range of 5° C. or less, the compensation unit 600 may recognize the booting as an instantaneous rebooting and maintain a gain value of compensation algorithm at the temperature saturation timing point just before the booting. For example, when the compensation algorithm starts from a predetermined timing point of the second to fourth sections (S2 to S4), the compensation unit 600 may perform the luminance compensation with a gain value optimized for the temperature difference between the reference saturation temperature and the current IC temperature.

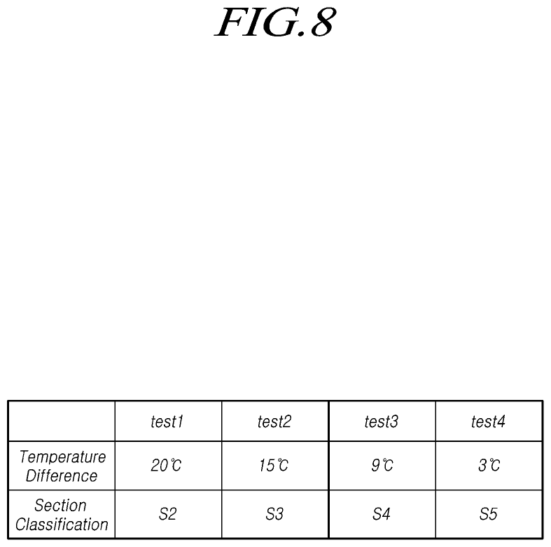

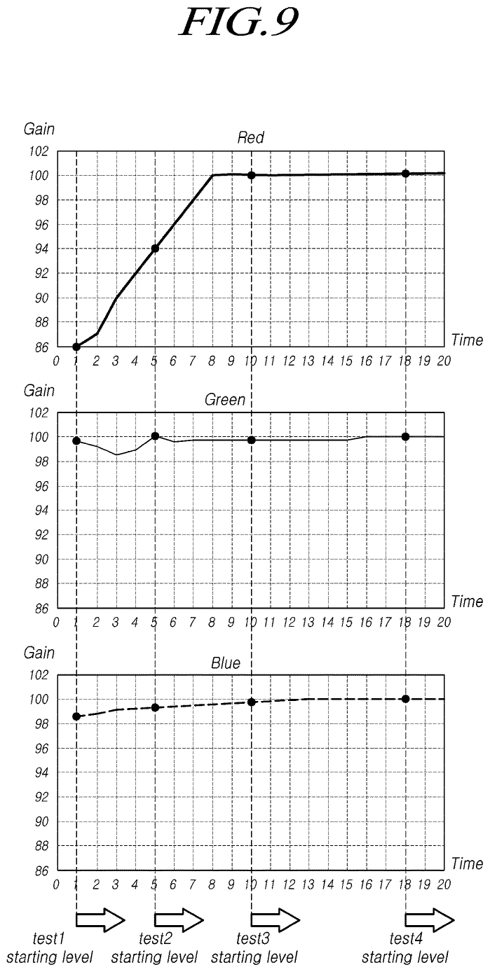

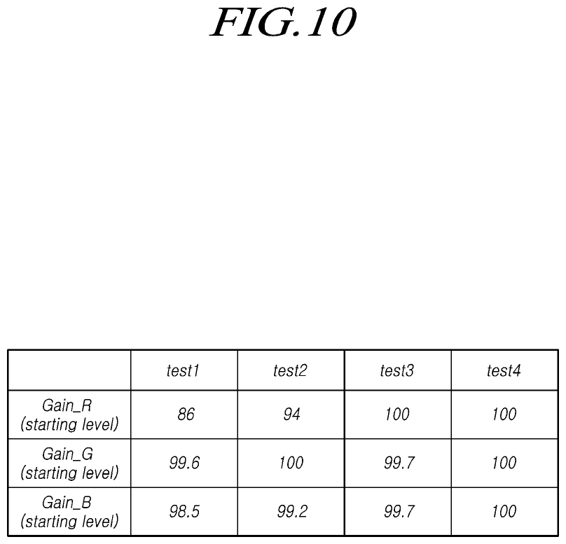

FIG. 8 illustrates a section classification according to an example test temperature difference, FIG. 9 illustrates a starting level of a compensation algorithm according to an example test temperature difference, and FIG. 10 illustrates an optimum gain applied upon booting according to an example test temperature difference.

Hereinafter, with reference to FIGS. 8 to 10, description will be made of the section classification for each temperature difference of the first to fourth tests based on example tests and the difference in the starting level of the compensation algorithm based on each section classification.

Referring to FIGS. 8 to 10, in the first test the temperature difference between the reference saturation temperature and the current IC temperature may be 20° C., in the second test the temperature difference between the reference saturation temperature and the current IC temperature may be 15° C., in the third test the temperature difference between the reference saturation temperature and the current IC temperature may be 9° C., and in the fourth test the temperature difference between the reference saturation temperature and the current IC temperature may be 4° C.

In the first test (test 1), the temperature difference (20° C.) is in the range of greater than 15° C. and less than or equal to 20° C., and thus the booting timing may be classified into the second section S2. At the booting timing for the first test may be applied an optimum gain corresponding to a predetermined relative driving timing point (e.g., 1 minute after the cold boot timing point) corresponding to the temperature difference of 20° C. For example, as shown in FIG. 10, at the booting timing for the first test, a gain value (Gain_R) for the red subpixel may be 86, a gain value (Gain_G) for the green subpixel may be 99.6, and a gain value (Gain_B) for the blue subpixel may be 98.5.

In the second test (test 2), the temperature difference (15° C.) is in the range of greater than 10° C. and less than or equal to 15° C., and thus the booting timing may be classified into the third section S3. At the booting timing for the second test may be applied an optimum gain corresponding to a predetermined relative driving timing point (e.g., 5 minutes after the cold boot timing point) corresponding to the temperature difference 15° C. For example, as shown in FIG. 10, at the timing point for the second test, a gain value Gain_R for the red subpixel may be 94, a gain value Gain_G for the green subpixel may be 100, and a gain value Gain_B for the blue subpixel may be 99.2.

In the third test (test 3), the temperature difference (9° C.) is within the range of greater than 5° C. and less than or equal to 10° C., and thus the booting timing may be classified into the fourth section S4. At the booting timing for the third test may be applied an optimum gain corresponding to a predetermined relative driving time (e.g., 10 minutes after the cold boot timing point) corresponding to the temperature difference of 9° C. For example, as shown in FIG. 10, at the booting timing for the third test, a gain value (Gain_R) for the red subpixel may be 100, a gain value (Gain_G) for the green subpixel may be 99.7, and a gain value (Gain_B) for the blue subpixel may be 99.7.

In the fourth test (test 4), the temperature difference (3° C.) is within the range of 5° C. or less, and thus the booting timing may be classified into the fifth section S5. At the booting timing for the fourth test may be applied an optimum gain corresponding to a predetermined relative driving timing point (e.g., 18 minutes after the cold boot timing point or at the temperature saturation timing point Tₜₛ) corresponding to the temperature difference 3° C. For example, as shown in FIG. 10, at the booting timing for the fourth test, a gain value (Gain_R) for the red subpixel may be 100, a gain value (Gain_G) for the green subpixel may be 100, and a gain value (Gain_B) for the blue subpixel may be 100.

As such, the display device 10 and its driving method of the disclosure may calculate a temperature difference between a reference saturation temperature and a current IC temperature at a boot timing point and determine a starting level of a compensation algorithm based on the temperature difference.

Accordingly, the display device 10 and its driving method of the disclosure may perform luminance compensation optimized for a service environment by reflecting the service environment before and after a power booting.

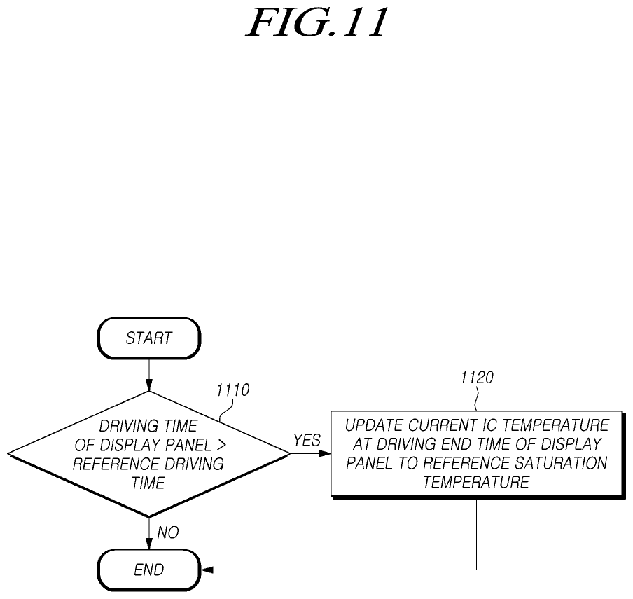

FIG. 11 illustrates an operation of updating a reference saturation temperature by a compensation unit 600 according to an embodiment.

Referring to FIG. 11, the compensation unit 600 may determine a driving time of the display panel 100 (operation 1110) and update the reference saturation temperature at the end timing point of the driving of the display panel 100 (operation 1120).

According to an example, in operation 1110, the compensation unit 600 may determine whether a driving time of the display panel 100 is equal to or greater than a reference driving time. Here, the reference driving time may be a driving time (e.g., 1 hour and 30 minutes) during which the temperature of the display panel 100 is saturated and thus does not increase any further. For example, the reference driving time may be changeable depending on the user setting. For example, when the driving time of the display panel 100 is equal to or greater than the reference driving time, the compensation unit 600 may determine that the temperature of the display panel 100 is saturated. For example, when the driving time of the display panel 100 is less than the reference driving time, the compensation unit 600 may determine that the temperature of the display panel 100 is not saturated.

In an embodiment, when the driving time of the display panel 100 is less than the reference driving time, the compensation unit 600 may not update the reference saturation temperature at the end time of driving of the display panel 100.

According to an example, in operation 1120, when the driving time of the display panel 100 is equal to or greater than the reference driving time, the compensation unit 600 may update the current IC temperature at the driving end time of the display panel 100 to the reference saturation temperature. The compensation unit 600 may recognize a driving end timing point for updating the reference saturation temperature. For example, the compensation unit 600 may recognize the driving end timing point based on at least one of an end signal, a standby mode signal, and a restart signal of the display panel 100. The compensation unit 600 may update the current IC temperature at the driving end timing point at which the temperature of the display panel 100 is saturated to a new reference saturation temperature. For example, the compensation unit 600 may update the reference saturation temperature, by deleting the existing reference saturation temperature from the memory and storing, in the memory, the current IC temperature at the driving end timing point as the new reference saturation temperature.

In an embodiment, once the reference saturation temperature is updated, upon generation of the power-on signal, the compensation unit 600 may compare the updated reference saturation temperature with the current IC temperature at the booting timing when the power-on signal is generated, thereby calculating the temperature difference. The compensation unit 600 may control a starting level of a compensation algorithm based on the temperature difference.

As such, the display device 10 and its driving method of the disclosure may continuously update the reference saturation temperature to reflect the reference saturation temperature changing according to the use of the display device 10 into the compensation algorithm.

Accordingly, the display device 10 and the driving method thereof according to the disclosure may perform a luminance compensation optimized for a service environment of the display device 10. However, since this concept has been already described above, redundant descriptions thereof will not be reiterated.

Electronic devices according to various embodiments disclosed in this document may be various types of devices. The electronic devices may include, for example, a portable communication device (e.g., smart phone), a computer device, a portable multimedia device, a portable medical device, a camera, a wearable device, or a home appliance. The electronic device according to embodiments of the disclosure is not limited to the aforementioned devices.

It should be appreciated that various embodiments of the disclosure and the terms used therein are not intended to limit the technological features set forth herein to particular embodiments and include various changes, equivalents, or replacements for a corresponding embodiment. In conjunction with the description of the drawing, similar reference numerals may be used for similar or related components. A singular form of a noun corresponding to an item may include one or more items unless the relevant context clearly indicates otherwise. As us ed herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled” or “connected” with/to another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic”, “logic block”, “part”, or “circuit”. Such a “module” may be a single integral component, or a minimum unit or a part of the component, adapted to perform one or more functions. For example, according to an embodiment, the module may be implemented in the form of an application-specific integrated circuit (ASIC).

Various embodiments as set forth herein may be implemented as software (e.g., program) including one or more instructions that are stored in a storage medium (e.g., an internal memory or an external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A display device, comprising:
a display panel configured to display an image;
a timing controller configured to control a data signal and a gate signal; and
a compensation unit configured to compensate for luminance of the image that is displayed on the display panel,
wherein the compensation unit,
detects generation of a power-on signal,
calculates a temperature difference between a reference saturation temperature and a current integrated circuit (IC) temperature, and
controls a starting level of a compensation algorithm based on the temperature difference.

2. The display device of claim 1, wherein the compensation algorithm comprises an optimum gain based on a relative driving time after a cold boot timing point of at least one of a red subpixel, a green subpixel, or a blue subpixel.

3. The display device of claim 1, wherein the compensation unit calculates the temperature difference based on a difference value between a pre-stored reference saturation temperature and the current IC temperature received from at least one temperature sensor.

4. The display device of claim 1, wherein the compensation unit classifies a booting timing at which the power-on signal is generated into any one section of a relative driving time based on the temperature difference.

5. The display device of claim 4, wherein the compensation unit:
classifies the booting timing into a first section, based on the temperature difference being in a range exceeding 20° C.;
classifies the booting timing into a second section, based on the temperature difference being in a range exceeding 15° C. and less than or equal to 20° C.;
classifies the booting timing into a third section, based on the temperature difference being in a range exceeding 10° C. and less than or equal to 15° C.;
classifies the booting timing into a fourth section, based on the temperature difference being in a range exceeding 5° C. and less than or equal to 10° C.; and
classifies the booting timing into a fifth section, based on the temperature difference being in a range of 5° C. or less.

6. The display device of claim 4, wherein the compensation unit starts the compensation algorithm from a predetermined timing point corresponding to the temperature difference within the any one section of the relative driving time, at the booting timing.

7. The display device of claim 6, wherein the compensation algorithm, at the booting timing, performs a luminance compensation for at least one of a red subpixel, a green subpixel, and a blue subpixel by applying an optimum gain corresponding to the predetermined timing point corresponding to the temperature difference.

8. The display device of claim 1, wherein the compensation unit:
determines whether a driving time of the display panel is greater than or equal to a reference driving time; and
based on the driving time of the display panel being greater than or equal to the reference driving time, updates the current IC temperature at a driving end time of the display panel to the reference saturation temperature.

9. The display device of claim 8, wherein the compensation unit recognizes the driving end time based on at least one of a termination signal, a standby mode signal, and a restart signal of the display panel.

10. The display device of claim 8, wherein the compensation unit, based on the power-on signal being generated, calculates the temperature difference by comparing the updated reference saturation temperature with the current IC temperature at a booting timing at which the power-on signal is generated.

11. A driving method of a display device, comprising:
controlling a data signal and a gate signal;
displaying an image; and
compensating for luminance of the displayed image,
wherein the compensating for the luminance comprises:
detecting generation of a power-on signal;
calculating a temperature difference between a reference saturation temperature and a current IC temperature; and
controlling a starting level of a compensation algorithm based on the temperature difference.

12. The driving method of claim 11, wherein the compensation algorithm comprises an optimum gain according to a relative driving time after a cold boot timing point of at least one of a red subpixel, a green subpixel, and a blue subpixel.

13. The driving method of claim 11, wherein the calculating the temperature difference comprises calculating the temperature difference based on a difference value between a pre-stored reference saturation temperature and the current IC temperature received from at least one temperature sensor.

14. The driving method of claim 11, wherein the controlling the starting level of the compensation algorithm comprises classifying a booting timing at which the power-on signal is generated into any one section of a relative driving time based on the temperature difference.

15. The driving method of claim 14, wherein the controlling the starting level of the compensation algorithm comprises:
classifying the booting timing into a first section, based on the temperature difference being in a range exceeding 20° C.,
classifying the booting timing into a second section, based on the temperature difference being in a range exceeding 15° C. and less than or equal to 20° C.,
classifying the booting timing into a third section, based on the temperature difference being in a range exceeding 10° C. and less than or equal to 15° C.,
classifying the booting timing into a fourth section, based on the temperature difference being in a range exceeding 5° C. and less than or equal to 10° C., and
classifying the booting timing into a fifth section, based on the temperature difference being in a range of 5° C. or less.

16. The method of claim 14, wherein the controlling the starting level of the compensation algorithm further comprises,
starting the compensation algorithm from a predetermined timing point corresponding to the temperature difference within any one section of the relative driving time, at the booting timing.

17. The method of claim 16, wherein the compensation algorithm, at the booting timing, performs a luminance compensation for at least one of a red subpixel, a green subpixel, and a blue subpixel by applying an optimum gain corresponding to the predetermined timing point corresponding to the temperature difference.

18. The method of claim 11, wherein the compensation algorithm further comprises:
determining whether a driving time of the display panel is greater than or equal to a reference driving time; and
based on the driving time of the display panel being greater than or equal to the reference driving time, updating the current IC temperature at a driving end time of the display panel to the reference saturation temperature.

19. The method of claim 18, wherein the determining whether a driving time of the display panel is greater than or equal to a reference driving time comprises,
recognizing the driving end time based on at least one of a termination signal, a standby mode signal, and a restart signal of the display panel.

20. The method of claim 18, wherein the calculating the temperature difference comprises,
calculating, based on the power-on signal being generated, the temperature difference by comparing the updated reference saturation temperature with the current IC temperature at a booting timing at which the power-on signal is generated.
